(19) United States
(12) Patent Application Publication
(10) Pub. No.: US 2019/0330863 A1
(43) Pub. Date: Oct. 31, 2019

(54) SAFETY CATCH FOR A BRACE FOR A PUMP JACK SCAFFOLD

(71) Applicant: Joseph Sanseverino, New Britain, CT (US)

(72) Inventor: Joseph Sanseverino, New Britain, CT (US)

(21) Appl. No.: 16/040,738

(22) Filed: Jul. 20, 2018

Related U.S. Application Data
(60) Provisional application No. 62/664,475, filed on Apr. 30, 2018.

(51) Int. Cl. E04G 5/06; E04G 5/04; E04G 1/38

(52) U.S. Cl. CPC E04G 5/061; F16M 13/02; E04G 1/38; E04G 5/04

(57) ABSTRACT

A brace for a pump jack scaffold pole. The brace has a first leg and a second leg, each extending between a mounting portion and a pole retaining portion. The mounting portion is configured to be secured to a structural member by a latch secured to the pole retaining portion. The latch is configured to releasably secure the pole therein. A safety catch is secured to at least one of the legs, the latch, and the pole retaining portion. The safety catch is being configured to releasably secure the pole therein.

### CROSS-REFERENCE TO RELATED APPLICATION

This application is a non-provisional application of, and claims priority to, U.S. Provisional Application No. 62/664,475, entitled “Safety Catch for a Brace for a Pump Jack Scaffold”, filed on Apr. 30, 2018, the entirety of which is incorporated by reference herein.

### BACKGROUND

Pump jack scaffolding systems provide easily translatable platforms to workers seeking access to a vertical surface. In these systems, a horizontal platform is secured to a number of stabilizing vertical poles via one or more pump jacks. Through operation of the pump jacks, the platform can be raised and lowered incrementally as needed to optimize the position of workers on the horizontal platform with respect to the vertical surface. In this way, the scaffolding does not need to be broken down and re-erected in order to better position workers finishing work at a first location for work at a second location. One or more braces can be connected between the vertical poles and the vertical surface to stabilize the scaffolding system and prevent tipping of the scaffolding.

However, the forces resulting from movement of the vertical poles and the scaffolding, e.g., caused by worker movement on the horizontal platform, can cause the brace connection to loosen, detach, or disconnect over time, particularly for taller systems used to reach taller vertical surfaces. If the brace becomes too loose, it may detach, which puts the system in danger of tipping over or at least becoming sufficiently unstable for a worker to lose their balance and fall. What is desired, therefore, is a fail-safe to help prevent failure of a pump jack scaffolding system in response to loosening or failing braces.

### SUMMARY

Systems and methods of the present disclosure are directed to a brace for a pump jack scaffold pole including at least one leg extending between a mounting portion and a pole retaining portion, the mounting portion being configured to be secured to a structural member. A latch is secured to the pole retaining portion, the latch being configured to releasably secure the pole therein. A safety catch is secured to the leg, the latch, and/or the pole retaining portion, the safety catch is configured to releasably secure the pole therein. In one embodiment, the safety catch includes one or more connectors for releasably securing the safety catch to the leg, the latch, and/or the pole retaining portion. In one embodiment, a portion of the safety catch is fixedly secured to the leg, the latch, and/or the pole retaining portion.

According to some embodiments, the present disclosure is directed to a brace for stabilizing a pole having two or more pole sections, wherein adjacent pole sections are connected at a pole junction, and one or more legs extend between a mounting portion and a pole retaining portion. The mounting portion is configured to be secured to a structural member. A latch is secured to the pole retaining portion, which is configured to releasably secure a portion of the pole junction therein. In one embodiment, a safety catch is secured to the leg, the latch, and the pole retaining portion. The safety catch is configured to releasably secure the portion of the pole junction therein. In one embodiment, the safety catch is fixedly secured to the leg, the latch, the pole retaining portion, or combinations thereof.

According to some embodiments, the present disclosure is directed to a method for mounting a scaffold pole to a structural member by securing the mounting portion of a brace to a structural member. The brace is secured to the scaffold pole by rotating a latch of the brace to secure the pole therein. The worker then accesses the structural member surrounding the mounting portion to secure an interlocking siding to the structural member. Moving the mounting portion from a first position to a second position allows access to additional portions of the structural member. The mounting portion fits between separate portions of the interlocking siding and allows the worker to mount a continuous surface of interlocking siding to the structural member. The brace can be used for a variety of tasks beyond mounting interlocking siding to the structural member.

In one embodiment a plurality of braces secure the scaffold pole to the structural member.

In one embodiment, the worker moves one of the braces from the first position to the second position while another of the braces remains attached to the structural member.

### BRIEF DESCRIPTION OF THE DRAWINGS

FIG. 1 is a partial perspective side view of a brace mounted to a structural member according to the present disclosure;

FIG. 2 is a partial perspective view of the brace of FIG. 1 in an open position with the pump jack scaffold pole omitted;

FIG. 3 is a partial perspective front view of the brace of FIG. 1 depicting the latch in greater detail and showing a safety catch of the present invention;

FIG. 4 is a partial perspective back view of the retaining portion of the brace depicted in FIG. 1 showing the safety catch of the present invention thereon;

FIG. 5 is a partial perspective front view of an alternative embodiment of the brace depicted in FIG. 3;

FIG. 6 is a partial perspective back view of an alternative embodiment of the brace depicted in FIG. 4 showing the safety catch of the present invention thereon;

FIG. 7 is a partial perspective back view of an alternative embodiment of the brace depicted in FIG. 4 showing the safety catch of the present invention thereon;

FIG. 8 is a partial perspective side view of a brace mounted to structural member, including the safety catch;

FIG. 9 is a partial perspective view of a brace that is positioned at a junction between adjacent sections of a sectioned pole;

FIG. 10A is a partial perspective view of a brace attached to the structural member at a first position;

FIG. 10B is a partial perspective view of a brace attached to the structural member at a second position;

FIG. 11A is a perspective view of the mounting portion depicted in FIGS. 10A and 10B;

FIG. 11B is an alternative perspective view of the mounting portion depicted in FIG. 11A;

FIG. 12A is a perspective view of the brace depicted in FIG. 2 in a closed position;

FIG. 12B is an enlarged perspective view of a portion of the brace depicted in FIG. 2;

FIG. 12C is an enlarged perspective view of an alternative portion of the brace depicted in FIG. 12B;

FIG. 13 is a partial perspective view of an assembly including two poles and two braces according to the present disclosure;

FIG. 14A is a perspective top view of the safety catch depicted in FIG. 2 a connector and a brace receiving area; and

FIG. 14B is a perspective top view of an alternative embodiment of the safety catch with two connectors depicted in FIG. 14A.

### DESCRIPTION

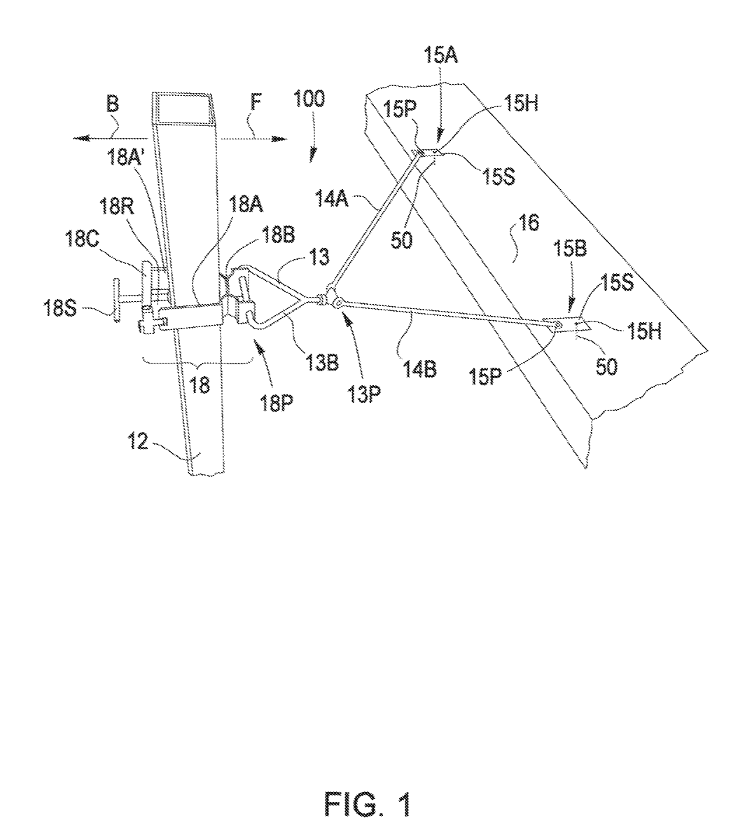

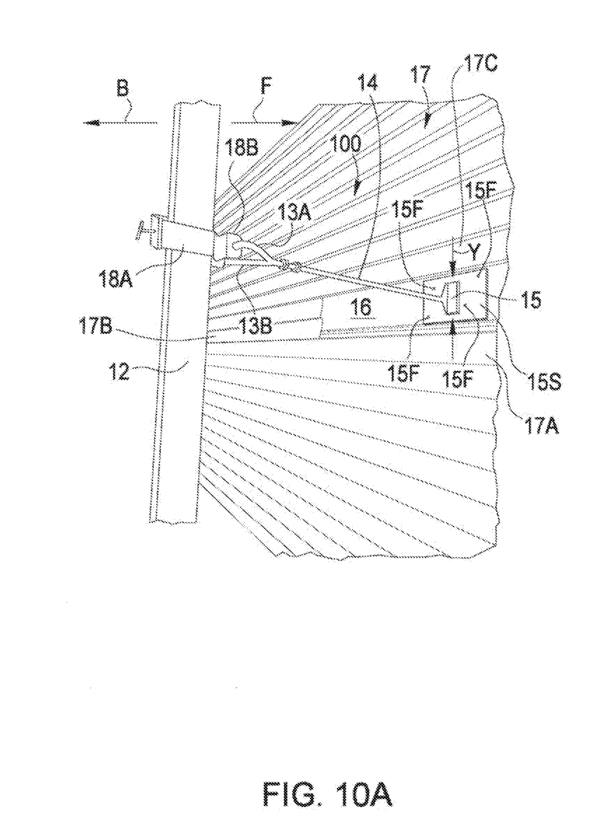

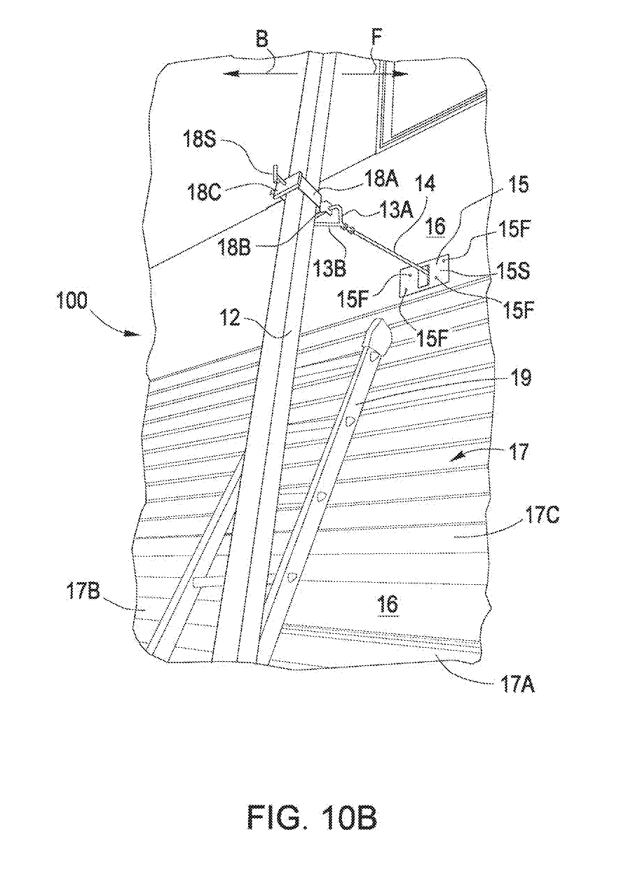

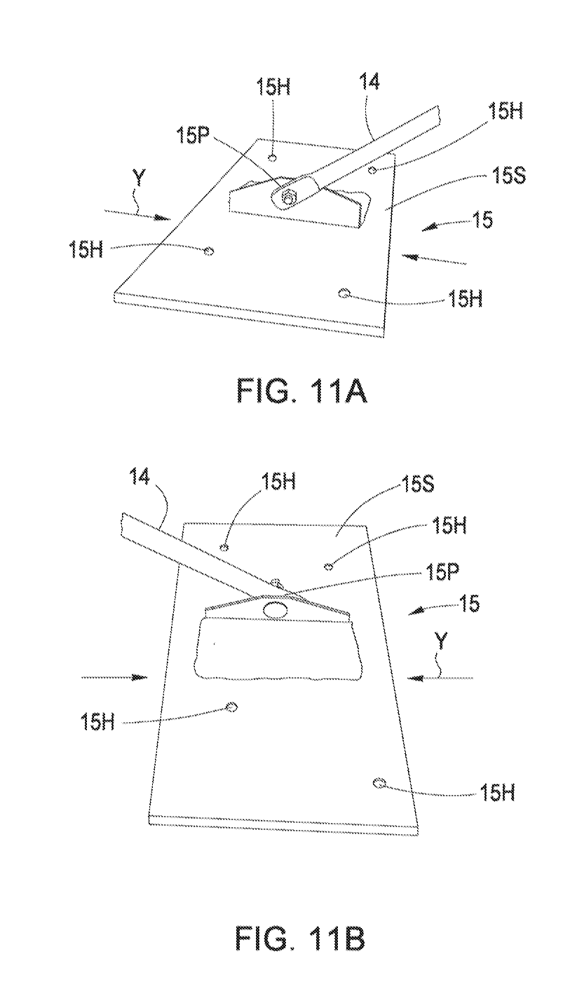

Referring now to FIG. 1, some embodiments of the present disclosure are directed to a brace 100 for a pump jack scaffold pole 12. The brace 100 includes first and second legs 14A and 14B. The first and second legs 14A and 14B include mounting portions 15A and 15B, respectively, configured to secure to a structural member 16. The mounting portions 15A, 15B include one or more mounting surfaces 15S that abut the structural member 16 and translate the securing force of the brace 100 to the structural member 16. In one exemplary embodiment, the mounting surface 15S includes a hole 15H, to facilitate securing the mounting portions 15A, 15B to the structural member 16 via fasteners 50, e.g., a screw, a bolt, a nail, a staple, etc., or combinations thereof. In the depicted embodiment, pivot joint 15P allows movement in the horizontal x direction between the structural member 16 and the legs 14A, 14B and prevents motion in the vertical y direction. One embodiment of the pivot joint 15P is depicted in detail in FIGS. 11A and 11B. While the brace 100 is shown with two legs 14A and 14B, the present disclosure is not limited in this regard (see FIGS. 10A-11B and 13). As few as one and as many as three or more legs can also be used. The structural member 16 is any suitable surface for fixing the brace 100 to that substantially limits movement of the brace 100 and the pump jack scaffold pole 12, e.g., an interior or exterior wall, a shelf, a pole, the ground, a roof, etc.

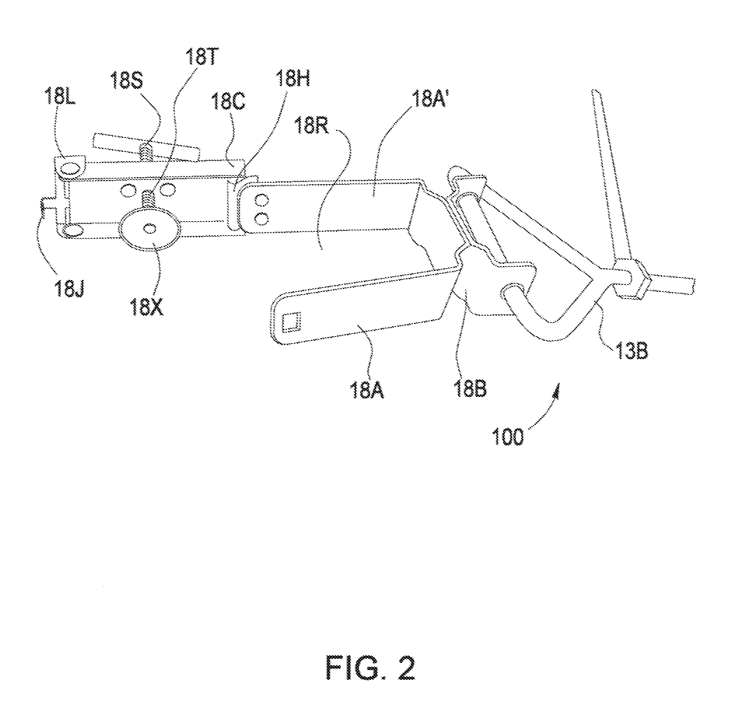

Still referring to FIG. 1, the brace 100 includes a pole retaining portion 13 connected to the first and second legs 14A, 14B. In one embodiment, the retaining portion 13 and the first and second legs 14A, 14B are rotatable or pivotable relative to each other, e.g., via a hinge or a ball and socket joint 13P. The retaining portion 13 includes a latch 18 that secures to the pole 12. In one embodiment, the retaining portion 13 includes a retaining portion base 13B between the legs 14A, 14B and the latch 18. In the depicted embodiment, the first leg 14A and second leg 14B engage the retaining portion 13 at pivot 15P. Referring now to FIG. 2, the latch 18 includes a latch base 18B and latch sides 18A, 18A′ which define a latch recess 18R. The latch 18 pivotally connects to the retaining portion 13 at joint 18P. The latch recess 18R is sized and shaped to accept a vertical section of the pump jack scaffold pole 12. The latch base 18B is configured to abut the pump jack scaffold pole 12 while held in the latch recess 18R and prevent forward movement in direction F, i.e., toward structural member 16 of the pump jack scaffold pole 12. The latch sides 18A, 18A′ are configured to substantially limit side to side motion of the pump jack scaffold pole 12 while in the latch recess 18R.

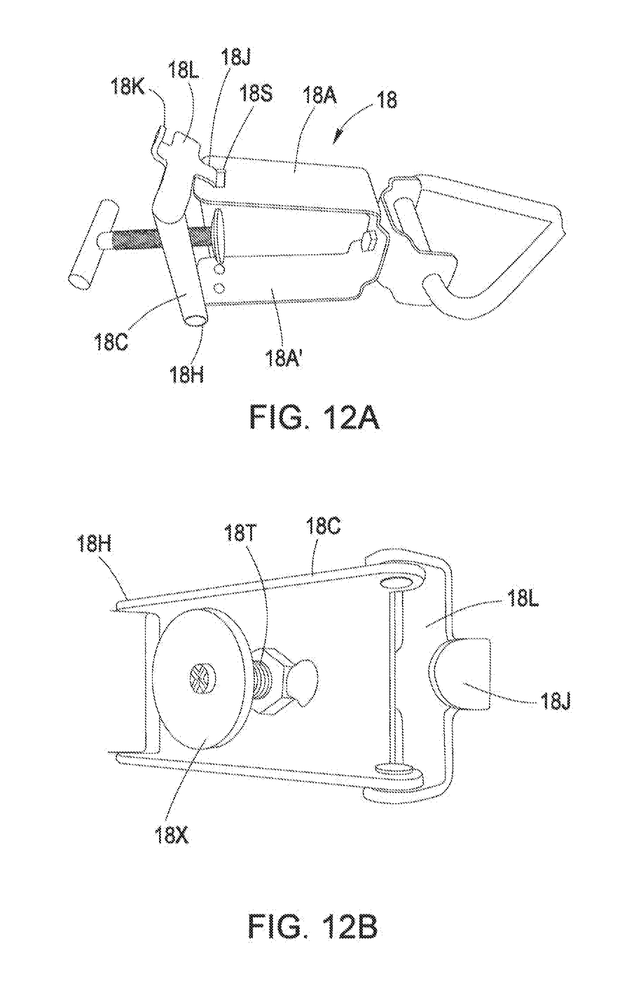

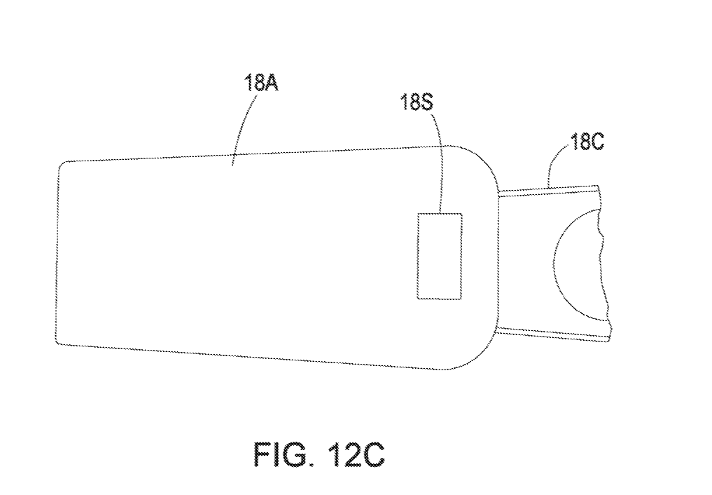

Referring to FIGS. 1 and 2, the latch 18 also includes a latch closure 18C opposing the latch base 18B. The latch closure 18C (e.g., flip gate latch) is configured to prevent backward movement in direction B (i.e., away from structural member 16) of the pump jack scaffold pole 12. A holding force is provided, e.g., by a screw 18S, to compress the pump jack scaffold pole 12 against at least one of the latch base 18B, latch sides 18A, and/or latch closure 18C. In one embodiment, the latch closure 18C is translatable between an open configuration and a closed configuration. In the open configuration (depicted in FIG. 2) the latch closure 18C is positioned to provide free access by the pump jack scaffold pole 12 (omitted for clarity) in the latch recess 18R. Once in the latch recess 18R, the latch closure 18C is translated to the closed configuration (depicted in FIG. 12A) and the movement of the pump jack scaffold pole 12 is limited by the latch recess 18R. In one embodiment, the latch closure 18C is hingedly fixed to one of the latch sides 18A′ at latch hinge 18H and releasably securable to another of the latch sides 18B. In the depicted embodiment, a latch flange 18X travels with the end of the screw 18S that retains the pump jack scaffold pole 12. The screw 18S twists through a threaded hole 18T in the latch closure 18C and the latch flange 18X exerts a force on the pump jack scaffold pole 12 towards the latch base 18B to retain the pump jack scaffold pole 12 within the latch recess 18R.While the latch base 18B and the latch closure 18C are shown and described herein as limiting or preventing forward and backward movement of the pump jack scaffold pole 12, the system of the present disclosure is not limited in this regard, as the brace 100 can also be configured so that the latch base 18B and the latch closure 18C limit or prevent side to side movement of the pump jack scaffold pole 12, while the latch sides 18A, 18A′ are configured to limit or prevent forward and backward movement.

The latch 18 is depicted in greater detail in FIGS. 12A-12C. In FIG. 12A, the latch 18 is in a closed position where a latch linkage 18L engages latch side 18A. The latch closure 18C rotates about the latch hinge 18H until latch linkage 18L engages the latch side aperture 18S (depicted in detail in FIG. 12C). In the depicted embodiment, latch linkage 18L rotates about the end of the latch closure 18C opposite from the latch hinge 18H. In the depicted embodiment, a closure tongue 18J and a closure handle 18K project away from the latch linkage 18L in generally opposite directions. The closure tongue 18J engages the latch side aperture 18S as depicted in FIG. 12A. The closure tongue 18J is depicted in detail in FIG. 12B. The closure handle 18K provides a surface for the worker to exert a force on the latch linkage 18L to move the closure tongue 18J to engage and disengage the closure tongue 18J with the latch side aperture 18S.

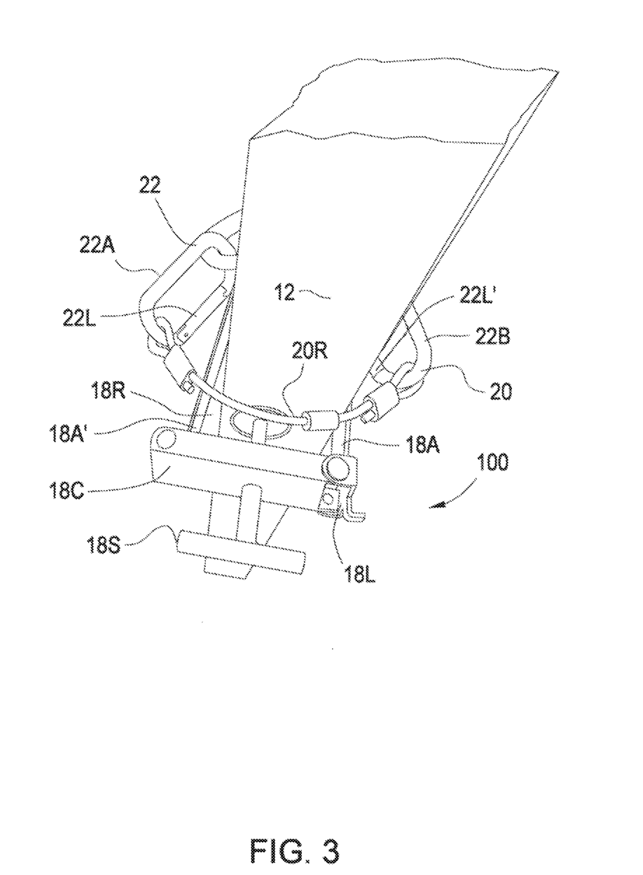

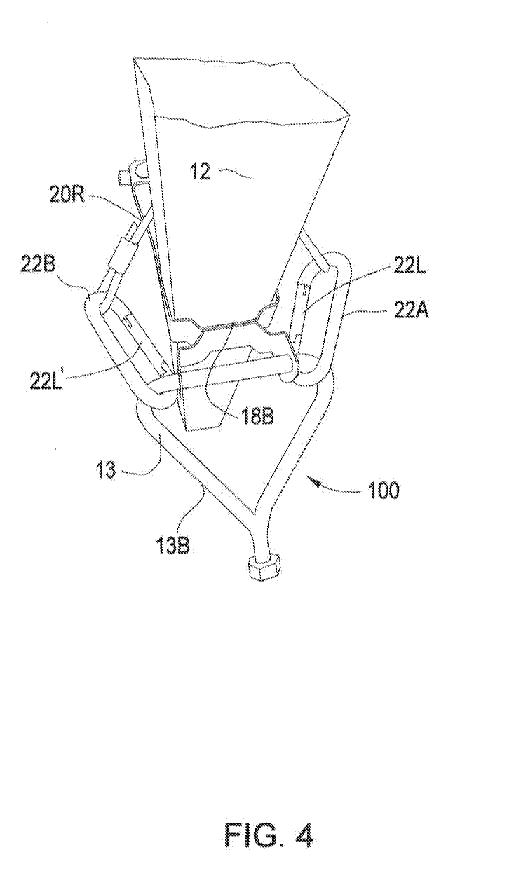

Referring now to FIGS. 3 and 4, the brace 100 includes a safety catch 20 configured as a fail-safe (e.g. backup) to releasably secure the pump jack scaffold pole 12 therein. The safety catch 20 includes a retaining portion 20R and connectors 22A, 22B. The retaining portion 20R, e.g. chain, cable, etc., provides a connection between the connectors 22A and 22B. In one embodiment, the connectors 22A, 22B are releasably secured by gate 22L, 22L′, respectively, to the legs 14A, 14B, the retaining portion base 13B, the latch 18, or combinations thereof. Connectors 22A and 22B are continuous loops when the latches 22L, 22L′ are in a closed position and are releasable when the latches 22L, 22L′ are in an open position. In the depicted embodiment, the latches 22L, 22L′ have a C-shaped body with a gate pivotally mounted at one end that is spring loaded towards the closed position. Other types of latches may be used as long as they provide a sturdy connection that is releasable, e.g. carabiners, locking carabiners, screw gates, etc.

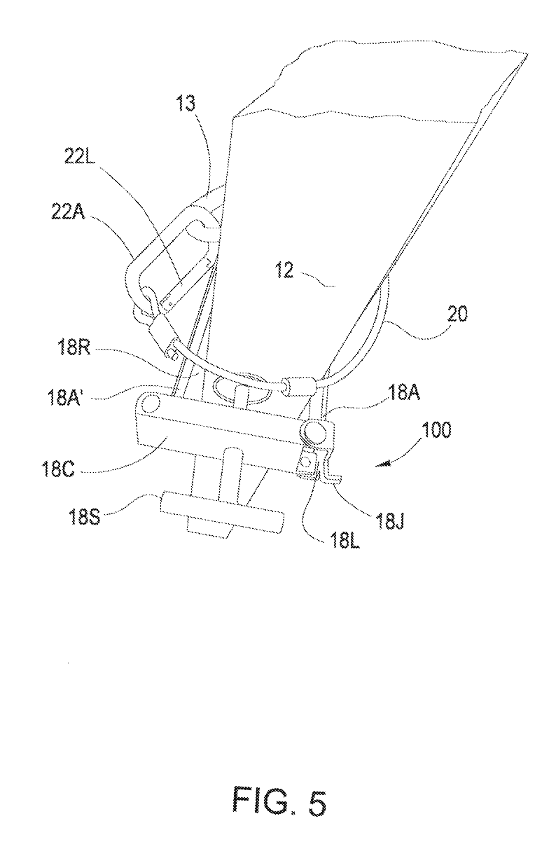

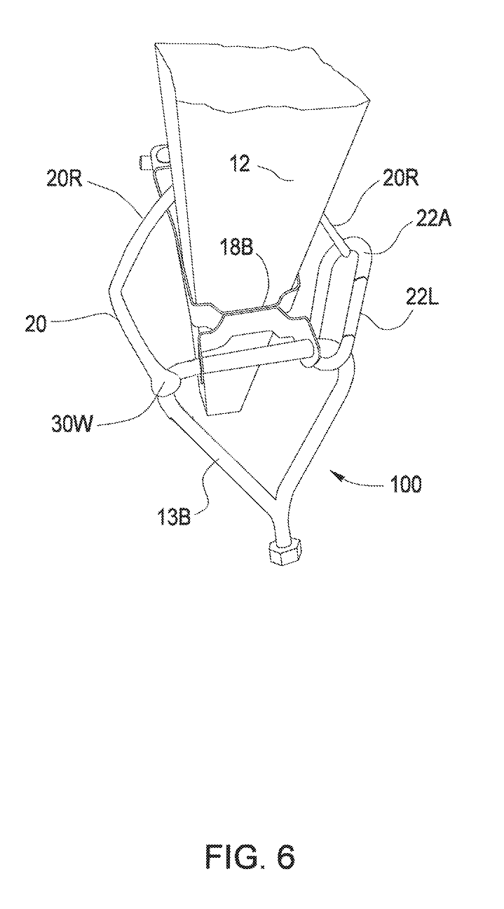

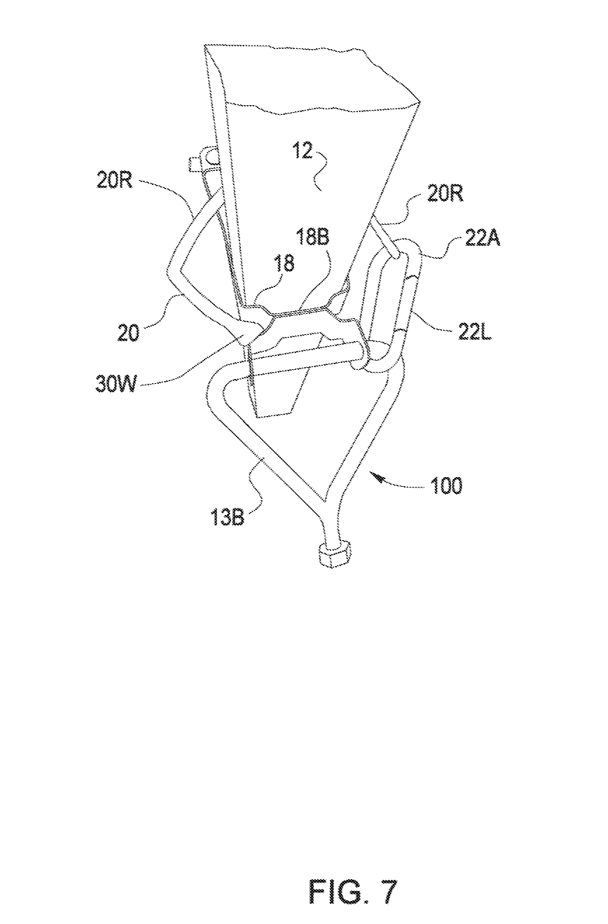

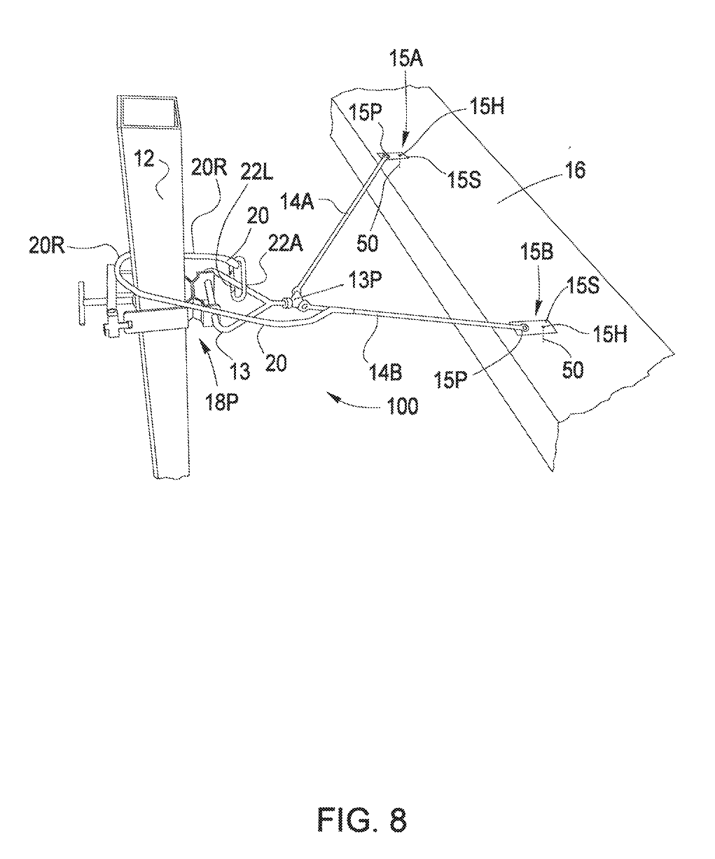

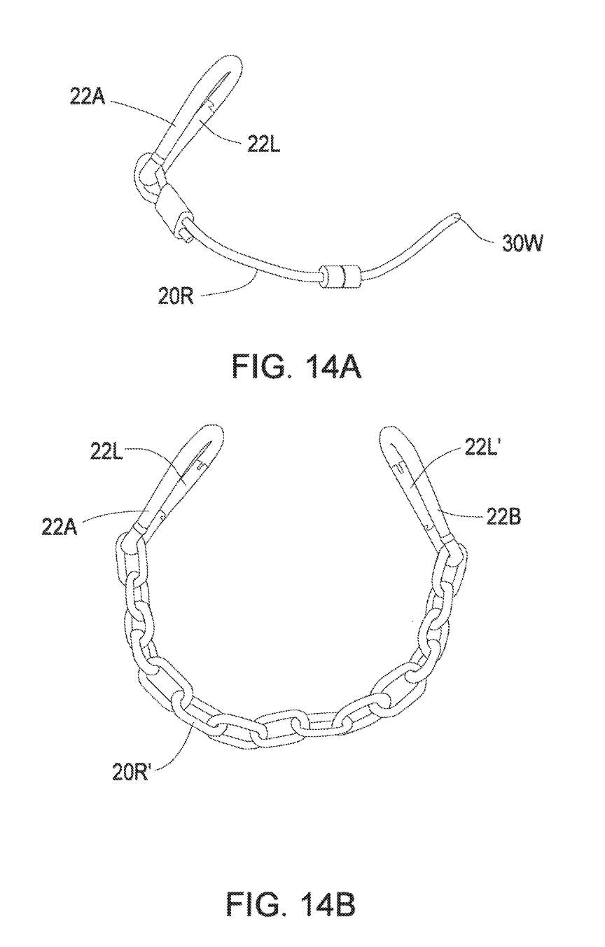

As shown in FIGS. 5-8, at least one of the connectors 22A, 22B is fixedly secured, e.g., welded , strapped, fastened, clamped, etc., to the legs 14, at a brace receiving area 30W the retaining portion base 13B, the latch 18, or combinations thereof. The retaining portion 20R is sized and shaped to loop around the pump jack scaffold pole 12 while the connectors 22A, 22B are secured as described above. Thus, in the event the brace 100 becomes loose and detaches from the pump jack scaffold pole 12, the safety catch 20 acts as a second level of security, backing up the latch 18 to prevent movement of the pump jack scaffold pole 12. In one embodiment, the retaining portion 20R is composed of a flexible material, e.g., a chain, wire, rope, etc., or combinations thereof. FIGS. 14A and 14B depict two embodiments of retaining portion 20R, 20R′, comprising a wire and chain, respectively. FIG. 14A depicts brace receiving area 30W that is permanently affixed to the retaining portion 13 (similar to FIG. 6). The brace receiving area may be incorporated into any connector in which one end is fixedly secured.

The poles 12 are only available in select lengths. Generally, the poles 12 have a length of 6, 12, 18, or 24 feet. It is common to need a total of 30 or more feet of pole for one pump jack scaffold assembly. In these scenarios, it is necessary to incorporate two poles in an end-to-end configuration to achieve the desired length. A brace 100 can be installed at the joint between the pole sections in order to significantly reduced movement of the pole relative to the structural member 16.

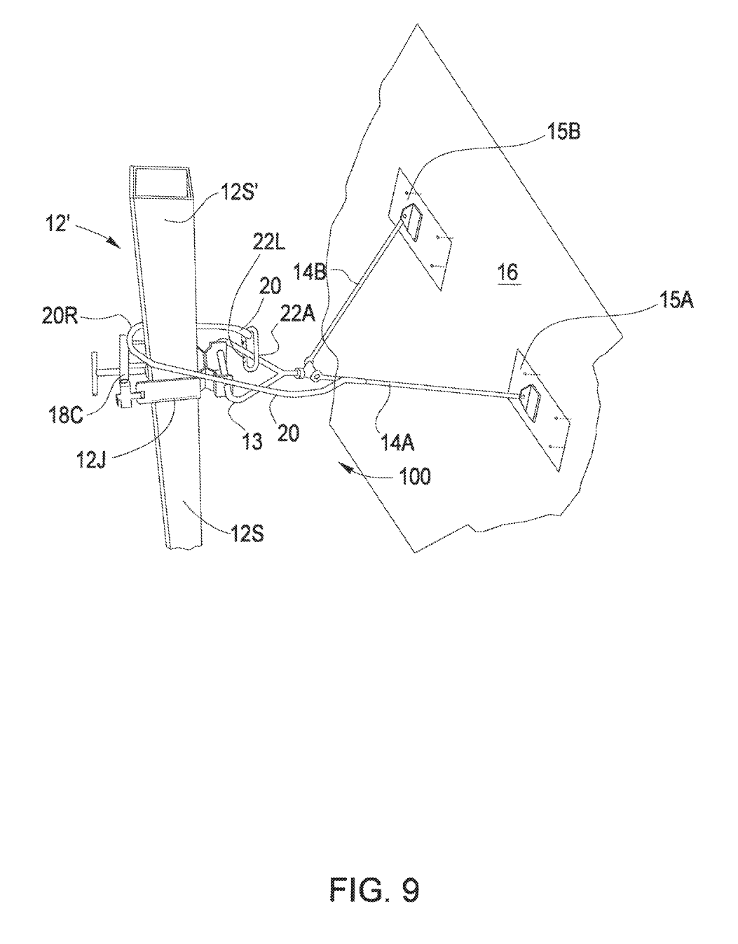

FIG. 9 depicts this end-to-end configuration. The brace 100 is positioned at a junction 12J between adjacent sections 12S, 12S′ of a sectioned pole 12′. In this embodiment, the mounting portions 15A, 15B are positioned on the structural member 16 to align the retaining portion 13 with the junction 12J between adjacent sections 12S, 12S′ of the sectioned pole 12′. The holding force provided by latch closure 18C abuts the junction 12J against one of the latch base 18B, latch sides 18A, and latch closure 18C of the brace 100. This holding force holds the brace 100 in place on the sectioned pole 12′ and helps to stabilize the junction 12J between adjacent sections 12S, 12S′ itself by providing an additional frictional fit with each section of the adjacent sections 12S, 12S′ of the sectioned pole 12′, limiting the ability of the adjacent sections 12S, 12S′ to move related to each other. In one embodiment, the safety catch 20 is releasably secured to the legs 14A, 14B, the retaining portion base 13B, the latch 18, or combinations thereof while the brace 100 is installed on the sectioned pole 12′. This arrangement has been found to reduce wobble or misalignment of the adjacent sections 12S, 12S′ of the pole 12′.

FIGS. 10A and 10B depict a brace 100 in use on the siding 17 of a house in a first position and a second position, respectively. In the depicted embodiment, the mounting portion 15 includes mounting surface 15S that is configured to fit between two portions 17A, 17C of the siding, engaging structural member 16. The mounting surface 15S includes four mounting apertures 15F to receive any suitable non-permanent securing mechanism, e.g., one or more fasteners 50.

Referring to FIG. 10A, the worker can secure the mounting surface 15S to structural member 16 in the first position. In one embodiment the first position places the mounting surface 15S at roughly the height of the worker. In the depicted embodiment, the siding 17A-17C interlocks with itself and the mounting surface 15S is the height of one portion of the siding 17B. Once the brace 100 is secured to the structural member 16 the worker can safely access and mount the siding 17A, 17C below and above the mounting surface 15S. The worker can also mount the siding 17B at the same height as the mounting surface 15S to the left and/or right of the mounting surface 15S.

FIG. 10B depicts the brace 100 in a second position. The worker can incorporate a ladder 19 to climb to the second position to secure the mounting surface 15S to the structural member 16 further away from the ground. In some embodiments two or more braces 100 are used and the worker attaches the braces 100 as the worker climbs further from the ground.

FIGS. 11A and 11B depict the mounting portion 15 in greater detail. The height “Y” is included in FIGS. 11A and 11B for clarity. The leg 14 rotatably connects to the mounting portion 15 at pivot joint 15P. The pivot joint 15P allows rotation of the leg 14 in the vertical y direction, but fixes the leg 14 in the horizontal x direction. This firmly secures the pole 12 while allowing the leg 14 to project at an angle from the bracket 18. The pivot joint 15P specifically accommodates rotation of the retaining portion 13 at latch base 18B (as depicted in FIGS. 10A and 10B). In some embodiments, a brace 100 is installed at the upper end of the pole 12 and engages a structural member 16 in the form of a roof (see FIG. 1). In this embodiment, there is an additional brace 100 part of the way up the pole 12. The length of the members from latch base 18B to the mounting surface 15S, including retaining portion 13 and leg 14 is the same from one brace to the next. As a result of the legs 14A, 14B connecting on top of an element (such as the structural member 16 depicted in FIG. 1) there is a shorter distance between the pole 12 and vertical surface of the structural member 16 at the top end of the pole 12 than at the bottom end of the pole 12 (near the ground). The mounting surface 15S depicted in FIGS. 10A and 10B accommodates a pole 12 that leans towards a wall in this manner. The legs 14A, 14B can project from latch base 18B at an angle to maintain a stable connection for the pole 12.

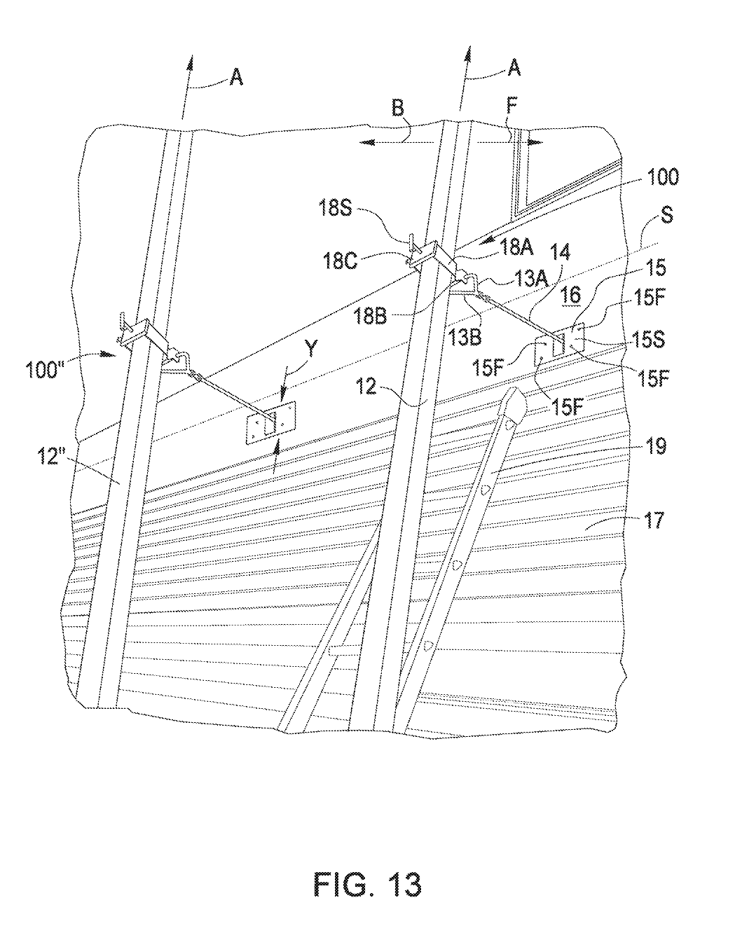

FIG. 13 depicts an embodiment in which a brace 100, 100″ is mounted on each of two poles 12, 12″. Traditionally, a horizontal platform (not depicted) is mounted to both poles 12, 12″ parallel to dashed line “S.” A worker pumps the platform to move it upwards (in direction A). Once the platform is at a desired height, the worker can then install the braces 100, 100″ to poles 12, 12″ below the horizontal platform to provide stability for the poles. Alternatively, another worker can follow the platform by climbing ladder 19 (which may be extendable) and mount the braces 100, 100″ from below. The worker can choose the desired height to mount the braces as well as the number of braces depending on the length of pole and other outside considerations (e.g., stability of ground underneath the poles, weight the platform must support, or other safety factors). The worker can start applying siding 17 to the structural member 16 up to a certain point and then leave a gap to accommodate the height “Y” of mounting surface 15S. Once the worker pumps the platform above the gap, the braces 100, 100″ can be mounted and the worker can continue pumping the platform upwards (in direction “A”). Once the worker reaches a desired height (such as the top of the structural member 16) and all necessary siding 17 is attached, the platform can then descend. As the platform descends to each brace 100, 100″, a worker standing on the platform or standing on a ladder 19 or the like below removes the braces 100, 100″ and the platform can continue to descend. As the platform passes the gaps that previously accommodated the mounting surface 15S, the worker can install a piece of siding 17 to form a continuous surface.

In one embodiment, the ground under the pole 12 is uneven or unstable, resulting in significantly more stress placed on the brace 100. In these scenarios, or in other applications that deem the extra safety necessary, a brace 100 is installed at ground level to provide a stable footing for the pole 12 and to provide kick out protection (preventing the bottom portion from moving away from the structural member 16).

In one embodiment, two 24 foot poles are mounted parallel to one another similar to the poles 12, 12″ depicted in FIG. 12. Braces are installed at the base of each pole and halfway up each pole. In another embodiment, the poles extend further and a brace is necessary every 20-30 feet to secure the poles to the structural member 16.

In one embodiment, the brace is manufactured from a metallic material such as iron-based alloy, steel, aluminum, etc. In one embodiment, the brace is manufactured from a synthetic material such as a plastic, carbon composite, etc.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

1. A brace for a pump jack scaffold pole comprising:
at least one leg extending between a mounting portion and a pole retaining portion, the mounting portion being configured to be secured to a structural member;
a latch secured to the pole retaining portion, the latch being configured to releasably secure the pole therein; and
a safety catch secured to at least one of the leg, the latch, and the pole retaining portion, the safety catch being configured to releasably secure the pole therein.

2. The brace of claim 1, wherein the safety catch comprises at least one connector for releasably securing the safety catch to the at least one of the leg, the latch, and the pole retaining portion.

3. The brace of claim 1, wherein at least a portion of the safety catch is fixedly secured to at least one of the leg, the latch, and the pole retaining portion.

4. The brace of claim 1, further comprising
a pole assembly having two or more pole sections, wherein adjacent pole sections are connected at a pole junction;
and the latch being configured to releasably secure at least a portion of the pole junction therein.

5. The brace of claim 4, further comprising a safety catch secured to at least one of the leg, the latch, and the pole retaining portion, the safety catch being configured to releasably secure the at least a portion of the pole junction therein.

6. The brace of claim 5, wherein at least a portion of the safety catch is fixedly secured to the at least one of the leg, the latch, the pole retaining portion, or combinations thereof

7. The brace of claim 5, wherein the at least one leg extends between a mounting portion and the pole retaining portion, the mounting portion being configured to be secured to a structural member at a mounting surface;
wherein the mounting surface has a size configured to fit between portions of interlocking siding mounted to the structural member.

8. The brace of claim 7, wherein the size of the mounting surface has a vertical dimension of between 3 and 5 inches.

9. The brace of claim 7, wherein the mounting surface is pivotally attached to the structural member to allow motion of the at least one leg in a horizontal direction.

10. The brace of claim 7, wherein the mounting surface is fixedly attached in both a horizontal direction and a vertical y direction to the structural member.

11. A method for mounting a scaffold pole to a structural member, the method comprising:
attaching portions of siding to the structural member up to a first position;
pumping a jack to raise a horizontal platform up the scaffold pole to above the first position;
securing mounting portions of a brace to the structural member at the first position below the horizontal platform;
rotating a latch of the brace to secure the scaffold pole therein beneath the horizontal platform;
accessing the structural member surrounding the mounting portion to secure portions of siding to the structural member up to a second position; and
pumping the jack to raise the horizontal platform up the scaffold pole above the second position; and
attaching the mounting portions of an additional brace to the structural member at the second position below the horizontal platform;
wherein the mounting portion has a size that is configured to fit between separate portions of the siding and allows mounting of a continuous surface of siding to the structural member.

12. The method of claim 11, further comprising only moving the mounting portion of one of the braces from the first position to the second position while another of the plurality of braces remains attached to the structural member.

13. The method of claim 11, further comprising:
releasing the jack to lower the horizontal platform to above the second position;
removing the brace immediately below the horizontal platform;
releasing the jack to lower the horizontal platform to a desired height;
installing a portion of siding to the structural member at the second position;
releasing the jack to lower the horizontal platform to above the first position;
removing the brace immediately below the horizontal platform;
releasing the jack to lower the horizontal platform to a desired height; and
installing a portion of siding to the structural member at the first position.

14. The method of claim 11, further comprising:
(a) providing a safety catch comprising a retaining portion and at least one connector; and
(b) securing the safety catch to the brace at two locations such that the safety catch and pole retaining portion or the safety catch and the latch surround the pump jack scaffold pole.

15. The method of claim 14, wherein the safety catch is releasably secured at one of the two locations.

16. The method of claim 14, wherein the safety catch is fixedly secured at one of the two locations.

17. A safety catch for a brace for a pump jack scaffold pole, the safety catch comprising:
at least one connector releasably secured to the brace; and
a retaining portion connected to the at least one connector;
wherein the at least one connector and retaining portion loop around the pump jack scaffold pole such that in combination with the brace the pump jack scaffold pole is surrounded.

18. The safety catch of claim 17, wherein one end of the retaining portion has a brace receiving area that is fixable to the brace.
